(19) United States
(12) Patent Application Publication
(10) Pub. No.: US 2007/0205260 A1
(43) Pub. Date: Sep. 6, 2007

(54) Media pick unit

(75) Inventor: Alan Tennant, Drum (GB)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 11/305,536

(22) Filed: Dec. 16, 2005

(51) Int. Cl. G07F 19/00; G06F 7/08

(52) U.S. Cl. 235/379; 235/381

(57) ABSTRACT

A detachable media pick unit is provided for use in an Automated Teller Machine dispenser unit. The pick unit comprises pick components, a transport mechanism and at least one motor, which is arranged to drive at least one of the pick components and the transport mechanism. The pick unit is detachably mountable in to a dispenser unit when in use. The media pick unit may also comprise a vacuum pump.

### TECHNICAL FIELD

The present invention relates to a media pick unit. It is particularly related to, but in no way limited to, a media pick unit for use in a self-service terminal (SST) for example for use with a currency cassette for use in an automated teller machine (ATM).

### BACKGROUND

Self-service terminals (SST) in the form of Automated Teller Machines (ATM) generally comprise media cassettes, pick units arranged to pick media from the cassettes and a media transport mechanism arranged to accept media from the pick mechanism and to transport the media to a position where it is available for collection by a user of the terminal.

A prior art ATM is now discussed, by way of an example, with reference to FIG. 1, which shows a schematic side elevation of a cash dispenser unit 73 of an ATM. The cash dispenser unit 73 holds a number of currency cassettes 89 each of which contains a stack of currency notes 68. Each cassette 89 holds only one denomination of currency notes, but different cassettes 89 may contain different denominations. The notes 68 are held in place in the cassette 89 by means of a pusher plate 69 which urges the stack of notes to one end of the cassette 89.

When one or more notes are to be dispensed from a particular cassette 89, a single, remote motor 118 drives, via a series of interconnected drive wheels, a media pick unit 74 associated with the cassette 89. The media pick unit comprises a moveable pick arm 120 with a suction cup 122, a pump arranged to create a vacuum in the suction cup to draw the note away, and a transport unit 228 comprising drive rollers, all of which are arranged locally to the media cassette 89 and are driven remotely via drive wheels by the motor 118. The pick arm moves the suction cup adjacent to the note to be extracted and the pump creates a vacuum which draws the note from the cassette. The note is then moved by the pick arm such that its leading edge is gripped between drive rollers of the transport mechanism 228.

The note is then fed along the feed path 72 by further drive rollers 92 which provide a conveyance means, through a retard mechanism 10 to a stacker wheel assembly 75 for stacking the notes prior to presentation to the user. The stacker wheel comprises a hub 76, bearing tines 78 arranged to rotate on a shaft 77. In operation, the stacker wheel assembly 75 rotates continuously in a counter-clockwise direction (for the arrangement shown in FIG. 1) and the note is fed into a compartment 81 formed between adjacent tines 78. If more than one note is to be dispensed, each note is fed into a successive compartment 81 as the stacker wheel assembly 75 rotates. Having completed half a rotation, the note is removed from the stacker wheel assembly 75 by fingers 94 of a stripper plate assembly 96 which is pivotally mounted on a shaft 98.

Once removed from the stacker wheel, the note is placed on a belt 100 resting against the stripper plate assembly 96 and any subsequent notes which are to be dispensed simultaneously with the first note are placed on top of the first note to form a bundle 68′. When the required amount of notes (which may be just one note) have been assembled into the bundle 68′, a pair of belts 102 (only one of which is shown in FIG. 1) is rotated on a shaft 104 such that the bundle 68′ is trapped between the belts 100, 102. The bundle is then fed between belts 100, 102, 106, 108 through a note exit slot 110 in the housing 112 of the cash dispenser unit 73 to a position where the bundle 68′ can be collected by the user of the ATM. If a multiple feeding is detected in the course of stacking the bundle of notes 68′ or one or more of the notes is rejected for any reason, the bundle is not fed to the note exit slot 110. Instead the stripper plate assembly 96 is pivoted into a position as shown by the dashed outline 96′ and the belts 100, 102 are operated in the reverse direction to deposit the bundle 68′ into a reject note container 114 via an opening 116.

A problem associated with the prior art dispenser is that maintenance repair and upgrading are all complex. For example, in prior art machines, a faulty pick unit would have to be serviced on site by a skilled technician, causing the ATM to be out of service for a considerable time. This requires partially dismantling the ATM and may require moving the ATM, usually requiring lifting gear, or the ATM would have to be removed to a workshop, again requiring lifting gear and further requiring transport of the usually heavy machinery. Either method of repair results in downtime for the ATM which is costly for the financial institution operating the ATM and may in extreme cases compromise the commercial viability of the ATM.

The mechanical complexity of an ATM dispenser unit comprising a plurality of interconnected pick means and a complex transport path cannot be over-emphasized. As FIG. 1 illustrates, to some degree, the dispenser unit may have three or four cassettes each of which is coupled to a single transport path which forms a single complex mechanical structure of wheels, belts and mechanical framework which has remained substantially unchanged since the inception of ATMs in the 1960's. It is this complex, rigid, interconnecting mechanical structure which makes the repair of ATM dispenser units so difficult, time consuming and costly.

### SUMMARY

According to a first aspect of the invention, there is provided a detachable media pick unit for use in an Automated Teller Machine dispenser unit, the pick unit comprising a) a pick means b) a transport mechanism, c) at least one motor arranged to drive at least one of the pick means and the transport mechanism, wherein the pick unit is detachably mountable in to a dispenser unit when in use.

The present invention lies, at least partially, in recognizing that because many of the components in the prior art machines are rigidly coupled into a single complex mechanism, it is difficult to quickly and easily repair and carry out maintenance and that a radically new approach to pick unit design would be required to address this problem. In this invention the problem is addressed by the modular nature of the media pick unit and by providing at least one motor dedicated to the media pick unit such that the media pick unit is operable substantially independently of the Automated Teller Machine (ATM) in which it is used. In other words, the or each motor is dedicated to the media pick unit such that it only drives entities incorporated within the media pick unit.

The use of a local, dedicated motor to drive the media pick unit allows the components of the pick unit to be driven locally, perhaps directly, rather than for example via a series of drive wheels or belts, makes the media pick unit more easily separable from a SST in which it is used. As the pick unit is removable, then an entire faulty unit could be replaced on site by an unskilled person and the necessary repairs carried out at the work shop but whilst the machine was available to users. A separable pick unit is easier to transport. Previously, the power to enable each of the media pick unit to function came from one motor, which drove all the components in a dispenser unit.

Preferably, the media pick unit further comprises a vacuum pump and the at least one motor is arranged to drive at least one of the pick means, the vacuum pump, and the transport mechanism. This is perhaps a preferred embodiment, but in other embodiments alternative pick means, such as friction pick means, may be used.

In a preferred embodiment, the media pick unit comprises a separate motor to directly drive each of the pick means, the vacuum pump, and the transport mechanism. This is advantageous as it allows the components to be independent of one another.

Preferably, at least one of the or each motor comprises a stepper motor. This is advantageous as stepper motors may be small and are precisely controllable.

According to a second aspect of the invention there is provided an automated teller machine comprising a dispenser unit including detachable media pick units as described above.

According to a third aspect of the present invention, there is provided a method of servicing an Automated Teller Machine (ATM) comprising providing at least one detachable media pick unit comprising

a) a pick means

b) a transport mechanism,

c) at least one motor arranged to drive at least one of the pick means and the transport mechanism

wherein the pick unit is detachably mountable in to a dispenser unit when in use, the method comprising removing and replacing an individual pick unit.

### BRIEF DESCRIPTION OF THE DRAWING

Embodiments of the invention will be described, by way of example, with reference to the following drawings, in which:

FIG. 1 is a schematic side elevation of a cash dispenser unit of a prior art ATM;

FIG. 2 is a simplified schematic diagram of one layer of a modular ATM including a detachable pick unit in accordance with one embodiment of the present invention; and

FIG. 3 shows a modular ATM in accordance with one embodiment of the present invention.

### DETAILED DESCRIPTION

Common reference numerals are used throughout the figures to indicate similar features.

Embodiments of the present invention are described below by way of example only. These examples represent the best ways of putting the invention into practice that are currently known to the Applicant although they are not the only ways in which this could be achieved.

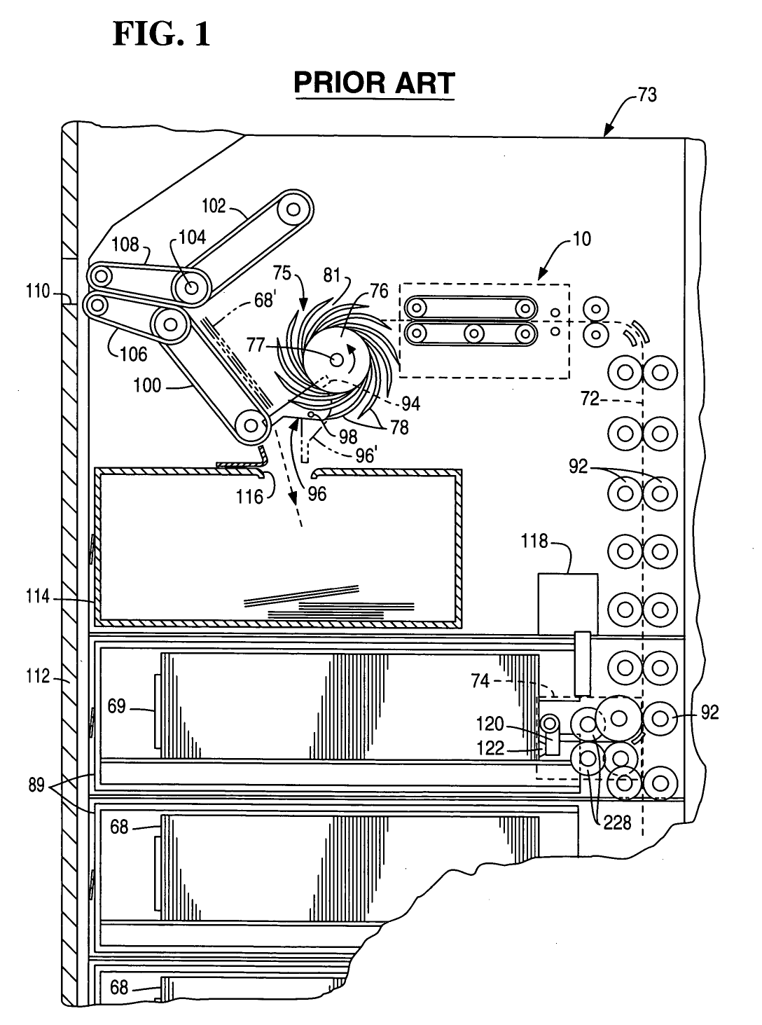

FIG. 1 show a prior art cash dispenser unit 73 from an Automated Teller Machine (ATM) and has been described above.

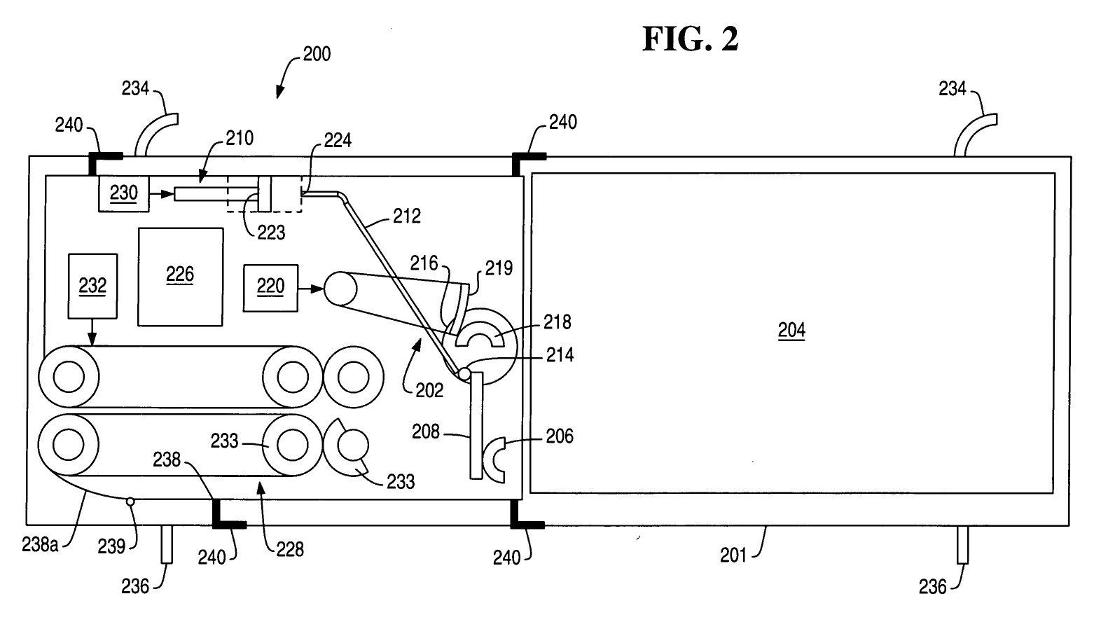

FIG. 2 shows a layer in a modular cash machine comprising a metal frame 201 housing a media pick unit 200 and a cash cassette 204. The media pick unit 200 comprises a pick means 202 arranged to pick currency notes held in the cash cassette 204, a pump 210, a transport mechanism 228 and control circuitry 226. The media pick unit 200 further comprise three motors: a pump motor 230, a pick arm motor 220 and a transport mechanism motor 232, each of which is a stepper motor arranged to be individually controlled by the control circuitry 226. The components are enclosed within a rigid plastic pick mechanism housing 238. The rigid plastic pick mechanism housing comprises a cut out portion 238a which is mounted to the body of the housing 238 at a hinge 239. The cut out portion 238a provides access to the interior of the unit 200 to allow an engineer to remove a jammed media, for example. The housing 238 further comprises attachment means 240 arranged to cooperate with the frame 201 so as to hold the unit 200 in position adjacent to the cash cassette 204.

The pump 210 comprises a piston 223 arrange to operate within a cylinder 224 and is driven by the pump motor 230. The pick means 202 comprises a suction cup 206 which is mounted on a pivoting pick arm 208. The suction cup 206 is connected to the pump 210 via a pick line 212, which continues through an internal duct in the pick arm 208. The pick arm 208 is mounted eccentrically to a point 214 on a rotating disc 216, which comprises a gear section 218. The gear section 218 co-operates with a driver gear portion 219, which is driven by the pick arm motor 220 causing the disc 216 to rotate.

It will be appreciated that in some embodiments, the arrangement of the components within the pick means 202 may vary. In particular, the pick arm 208 may be driven by the pick arm motor 220 directly rather than via cams or gears as described above. However, in order to enable direct driving of the pick arm a stepping motor with software control would be required to control the movement of the arm to and from the note stack.

The transport mechanism 228 comprises drive rollers 233 arranged to grip a sheet passed thereto by the pick means 202 and to carry it out of the unit 200 in order to be dispensed to a user of an ATM in which the pick unit 200 is installed. The transport mechanism 228 is driven by the transport mechanism motor 232.

In use of the pick unit 200, the control circuitry 226 controls the pump motor 230, the pick arm motor 220 and the transport mechanism motor 232 separately as follows.

When a note is to be picked the pick arm motor 220 drives the gear section 218 on the rotating disc 216, causing the point 214 at which the pick arm 208 is held to move such that the suction cup 206 is brought into contact with the uppermost sheet in a stack of sheets stored in the cash cassette 204. The control circuitry 226 then causes the pump motor 230 to control the pump 210, which partially evacuates the pick line 212 and the volume enclosed between the suction cup 206 and the sheet. After a predetermined portion of a stroke of the pump 210 (after which the pressure reached in the pump cylinder 224 is sufficient to attach a sheet to the suction cup 206 by suction), the control circuitry 226 stops the pump motor 230 and drives the pick arm motor 220 such that the movement of the rotating disc 216, moves the suction cup 206 away from the cash cassette 204 with the sheet held thereto by suction.

The sheet is then transported to the mouth of the transport mechanism 228 by the pick arm motor 220. The control circuitry 226 then controls the transport mechanism motor 232, turning the rollers 233 such that the sheet is drawn into the transport mechanism 228 and is carried away by a conveyance means in order to be dispensed to a user of the ATM.

The frame 201 further comprises an attachment means 234 on its upper face in the form of a hook and a rod 236 on its lower face. The arrangement is such that the hook attachment means 234 of one such layer is arranged to co-operate with the rod 236 of a similar layer such that one can hang from another.

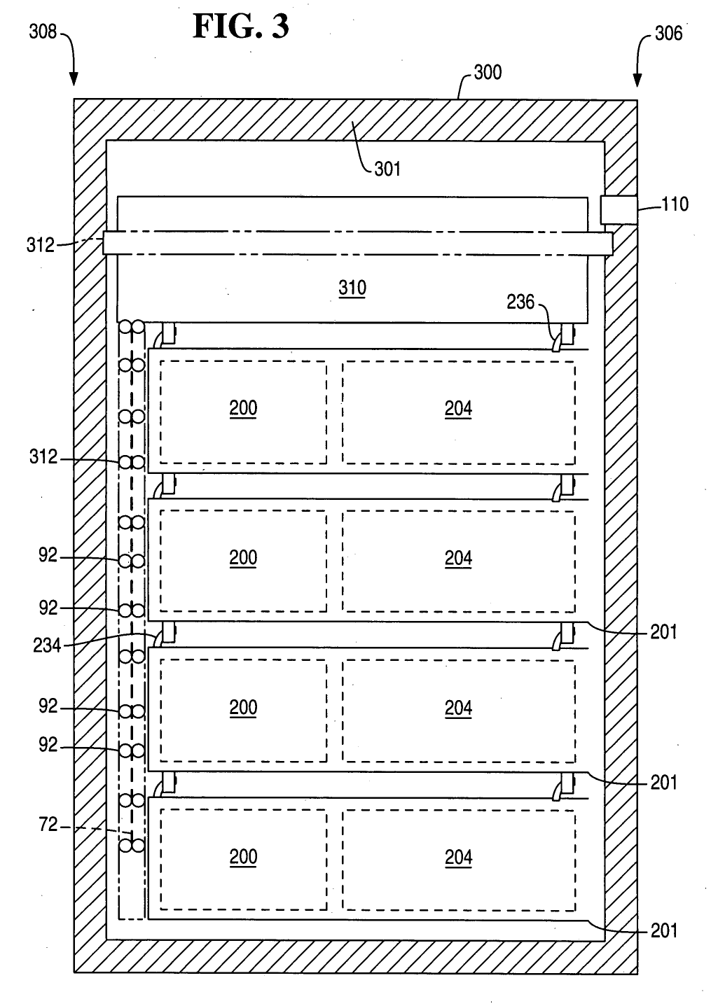

FIG. 3 shows the layer shown in FIG. 2 as a component in a modular ATM 300. The ATM 300 comprises a housing 310 including note dispense slot 110 on a face 306 of the ATM which is accessibly by a user. The rear face of the ATM comprises a door 308 which may be removed to allow access to the interior of the ATM 300, for example to replace the cash trays 204 or to maintain the pick units 200.

The ATM 300 comprises a stack of pick units 200 and associated currency cassettes 204. Above the uppermost pick unit 200 there is located a dispensing unit 310. The dispensing unit 310 comprises drive rollers, a retard mechanism, a stacker wheel assembly, a stripper plate assembly and belts arranged to dispense notes or to divert them to a purge bin in known manner. The dispensing unit 310 further comprises rod 236 on its lower face like those described in relation to the layers containing the pick units 200.

Improved dispenser unit design, as is the subject of a separate invention in the name of the applicant, can also be utilized but is not detailed herein for simplicity.

The dispensing unit 310 is supported on rails 312 which run the length of one side of the ATM 300 and comprise sliders such that the ATM may be slid in and out of it housing.

There are four pick units 200, each of which comprises a layer with an associated cash cassette 204 hooked onto the one above by the hook attachment means 234 co-operating with the rod 236 of the layer above it.

The ATM 300 further comprising a conveyance means 314 comprising drive rollers 92 between which a feed path 72 is formed. Sheets from each layer may be introduced into the transport means 314, by the transport mechanism 228 of each pick unit 200.

It will be noted that the ATM ‘hangs’ from the rails 312 rather than rests on the ground. This causes less damage to the components of the ATM 300 through vibration and the like.

Pick units 200 and cassettes 204 in accordance with the present invention may be combined in any suitable combination or orientation.

Any range or device value given herein may be extended or altered without losing the effect sought, as will be apparent to the skilled person.

The steps of the methods described herein may be carried out in any suitable order, or simultaneously where appropriate.

It will be understood that the above description of a preferred embodiment is given by way of example only and that various modifications may be made by those skilled in the art. For example, there may be only one motor within the media pick unit 200, or two. The pick means may be a friction pick means, in which case there would be no need for a pump 210 and an associated pump motor 230.

1-12. (canceled)

13. An apparatus for use in a self-service terminal, the apparatus comprising:
a pick mechanism for picking media contained in a media cassette;
a transport mechanism for transporting media which has been picked from a media cassette to a location away from the media cassette;
a first motor coupled to the pick mechanism;
a second motor different from the first motor and coupled to the transport mechanism; and
control circuitry for controlling the first and second motors independently of each other to thereby control operation of the pick mechanism and operation of the transport mechanism independently of each other.

14. An apparatus according to claim 13, further comprising:
a vacuum pump for co-operating with the pick mechanism to pick media contained in a media cassette; and
a third motor different from the first and second motors and coupled to the vacuum pump;
wherein the control circuitry controls the third motor independently of the first and second motors to thereby control operation of the vacuum pump independently of operation of the pick mechanism and operation of the transport mechanism.

15. An apparatus according to claim 14, wherein each of the first, second, and third motors comprises a stepper motor.

16. An apparatus for use in a self-service terminal, the apparatus comprising:
a vacuum pump for picking media contained in a media cassette;
a transport mechanism for transporting media which has been picked from a media cassette to a location away from the media cassette;
a first motor coupled to the vacuum pump;
a second motor different from the first motor and coupled to the transport mechanism; and
control circuitry for controlling the first and second motors independently of each other to thereby control operation of the vacuum pump and operation of the transport mechanism independently of each other.

17. An apparatus according to claim 16, wherein each of the first and second motors comprises a stepper motor.

18. An automated teller machine (ATM) comprising:
a dispensing unit;
a plurality of currency cassettes for containing currency notes; and
a plurality of pick units, each pick unit being associated with a corresponding one of the plurality of currency cassettes, each pick unit including (i) a pick mechanism for picking currency notes contained in the associated currency cassette, (ii) a transport mechanism for transporting currency notes which have been picked from the associated currency cassette to the dispensing unit, (iii) a vacuum pump for co-operating with the pick mechanism to pick currency notes contained in the associated currency cassette, (iv) a first motor coupled to the pick mechanism, (v) a second motor different from the first motor and coupled to the transport mechanism, (vi) a third motor different from the first and second motors and coupled to the vacuum pump, and (vii) control circuitry for controlling the first, second, and third motors independently of each other to thereby control operation of the pick mechanism, operation of the transport mechanism, and operation of the vacuum pump independently of each other.

19. An ATM according to claim 18, wherein each of the first, second, and third motors comprises a stepper motor.
